(19) United States
(12) Patent Application Publication
(10) Pub. No.: US 2026/0187633 A1
(43) Pub. Date: Jul. 2, 2026

(54) PRE-AUTHENTICATION FOR PREDICTED FUTURE TRANSACTIONS

(71) Applicants: American Express Travel Related Services Company, Inc., New York, NY (US); AMEX Canada, Inc., North York (CA)

(72) Inventors: Magdalena McGoldrick, East York (CA); Ashley Sjostrom Brailey, Garwood, NJ (US); Mukund Shankar SimhaRaghu, Glendale, AZ (US)

(21) Appl. No.: 19/004,727

(22) Filed: Dec. 30, 2024

(51) Int. Cl. G06Q 20/40

(52) U.S. Cl. CPC G06Q 20/401

(57) ABSTRACT

Disclosed are various embodiments for pre-authenticating future transactions to enable users to engage in a transaction without a need for real-time authentication. A future transaction can be identified based at least in part on analyzing transaction data to determine patterns in a user's behavior or in response to receiving a pre-authentication request from a client device. Pre-authentication data can be generated by the issuer of a credential predicted to be used in the future transaction along with a risk level associated with the authentication. A client device can present transaction data with the pre-authentication to a terminal and the terminal can validate the pre-authentication prior to approving or denying the transaction.

### BACKGROUND

Applications that are executed on a client device (e.g., laptop, desktop, mobile phone, tablet, etc.) may need to interact with backend functionality for authentication prior to performing different tasks (e.g., transactions, access, identification, etc.). Backend authentication relates to the verification of one's identity on a server-side of an application and can provide a centralized and enhanced security. When an application is offline or otherwise is unable to connect to the backend for authentication, the application will be unable authenticate the user and therefore be unable to perform a given operation.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing depicting one of several embodiments of the present disclosure.

FIG. 2 is a drawing of a network environment according to various embodiments of the present disclosure.

FIG. 3 is a sequence diagram illustrating examples of functionality in the network environment of FIG. 2 according to various embodiments of the present disclosure.

FIG. 4 is a flowchart illustrating one example of functionality implemented as portions of an issuer service executed in a computing environment in the network environment of FIG. 2 according to various embodiments of the present disclosure.

FIG. 5 is a flowchart illustrating one example of functionality implemented as portions of an issuer service executed in a computing environment in the network environment of FIG. 2 according to various embodiments of the present disclosure.

FIG. 6 is a flowchart illustrating one example of functionality implemented as portions of a wallet application executed in a client device in the network environment of FIG. 2 according to various embodiments of the present disclosure.

FIG. 7 is a flowchart illustrating one example of functionality implemented as portions of a terminal service executed in a terminal in the network environment of FIG. 2 according to various embodiments of the present disclosure.

### DETAILED DESCRIPTION

Disclosed are various approaches for pre-authenticating future transactions to enable users to engage in a transaction without a need for real-time authentication. According to various examples, an issuer of a credential (e.g., payment, access, identification, etc.) can preauthorize the use of the credential for a future transaction in response to identifying a future transaction that may require authentication. For example, if a device is operating in an offline mode, the device may not be able to obtain real-time authentication from an issuer to engage in a transaction that requires authentication. In various examples, patterns in a user's behavior and/or a direct request from the user can be used to identify a future transaction that may require authentication. By being able to predict a future transaction as well as provide pre-authentication to avoid the need for real-time authorization, issuers can allow users to transact in offline modes without real-time authentication while limiting a merchant's or recipient's risk exposure.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

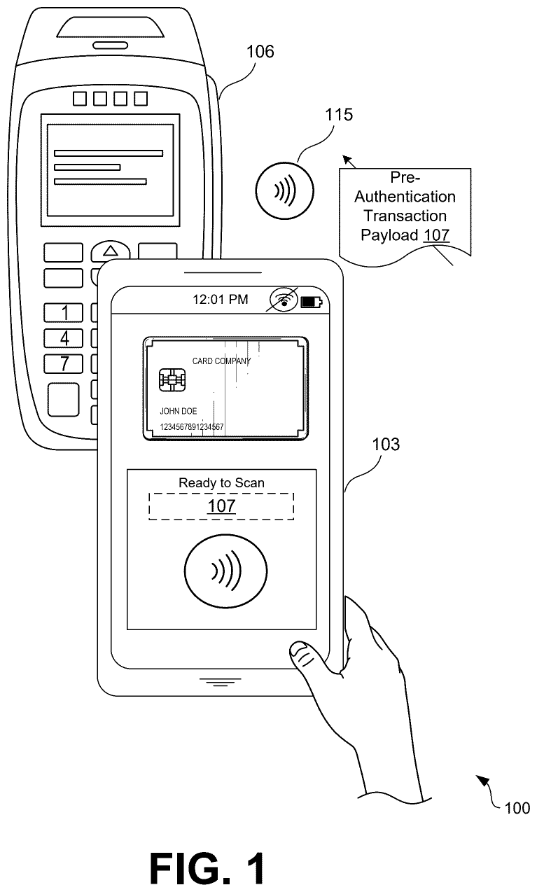

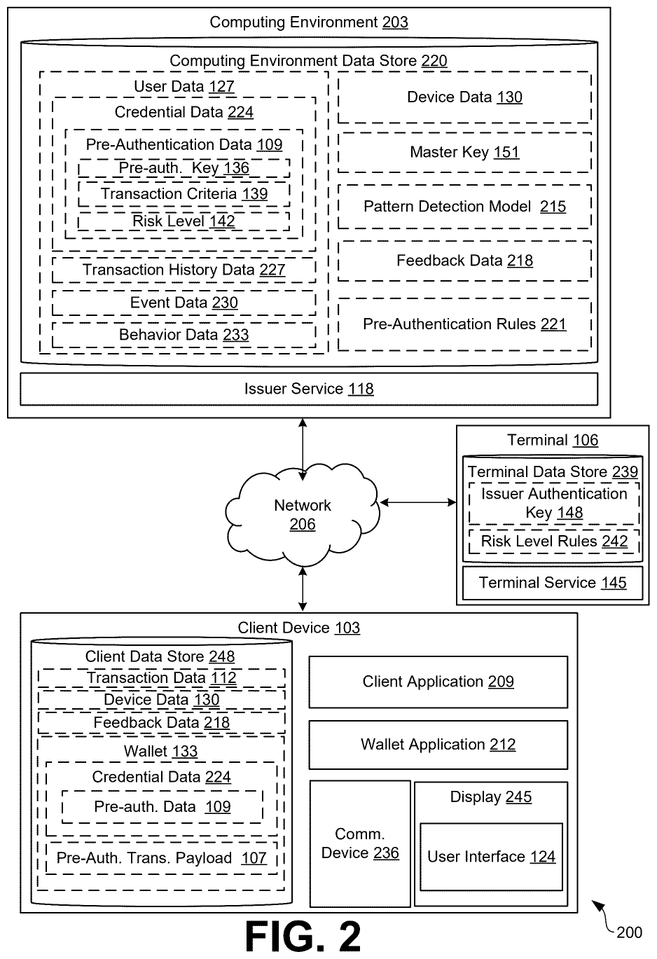

As illustrated in FIG. 1, shown is an example scenario 100 in which a client device 103 that is operating in an offline mode is able to transact with a terminal 106 by presenting a pre-authentication transaction payload 107 that includes transaction data 112 (FIG. 2) with authentication based at least in on pre-authentication data 109 (FIG. 2). In particular, the example scenario 100 of FIG. 1 relates a client device 103 tapping or otherwise being placed in an appropriate proximity to a terminal 106 to establish a direct wireless connection 115 (e.g., near field communication (NFC), Bluetooth, etc.) for the transaction that requires authentication. In this example, the client device 103 is offline (e.g., lacking a network connection) and needs to perform a transaction that is typically performed when the client device 103 is in an online mode (e.g., connected to a back-end computing environment via a network) so that the client device 103 can obtain real-time authentication to perform the transaction with the terminal 106.

According to various examples, an issuer service 118 (FIG. 2) associated with an issuer of a credential (e.g., payment credential, identification credential, access credential, loyalty account credential, etc.) can identify a future transaction requiring authentication based at least in part on a behavior pattern of the user and/or on a pre-authentication request received from the client device 103 in response to user interactions with a user interface 124 rendered on the client device 103. In one example, a user interacting with a user interface 124 associated with the issuer service 118 and rendered on the client device 103 can request pre-authentication for a future transaction. In this example, the pre-authentication request can include details associated with the request including a merchant identifier, an expected transaction amount, an expected transaction date/time, and/or other data.

In some examples, the issuer service 118 can analyze historical data (e.g., user spend behavior at given terminals 106, dispute data associated with merchants, terminals 106, users, etc.), geolocation, time-bound wallet passes (e.g., event tickets, etc.) to assess or otherwise detect behavior patterns that can be used to validate reliability and a need for pre-fetched authentication. In some examples, the historical data can include user data 127 and device data 130 received from the client device 103 that can be used identify behavior patterns of the user that may indicate a future transaction and corresponding risk. For example, a behavior pattern can indicate that after a user visits a particular retail store, they typically visit a coffee shop to purchase coffee. As such, the future transaction can correspond to the coffee purchase at the second store based at least in part on the user vesting the retail store and his or her inferred behavior patterns. In another example, the issuer service 118 can detect future transactions based at least in part on a scheduled event. For example, if a user is scheduled to attend a concert, the user's behavior patterns may indicate that the user typically buys merchandise and concessions when attending concerts.

In some examples, the issuer service 118 can analyze the historical data periodically. In other examples, the issuer service 118 can analyze the historical data based at least in part on a need, such as, for example, a scheduled event (e.g., detection of a time-bound pass in a user wallet 133 (FIG. 2)), a pre-authentication request, and/or other type of future transaction indicator. In various examples, the issuer service 118 can identify a risk associated with the future transaction and corresponding pre-authentication. For example, the issuer service 118 can analyze the user data 127, device data 130, and/or other data to determine a level of risk that is placed on a credential receiving entity (e.g., merchant, access provider, etc.) for approving a transaction that is based on a pre-authentication when the client device 103 is offline. As such, the credential receiving entity, via the corresponding terminal 106, can determine whether to approve and/or deny a transaction with a client device 103 based at least in part on the risk level and proof of pre-authentication.

In various examples, the issuer service 118 can generate pre-authentication data 109 that is associated with a given terminal 106 and/or merchant in response to predicting or otherwise identifying a future transaction. The pre-authentication data 109 can include an authentication key 136, transaction criteria 139, a risk level 142, and/or other data associated with the pre-authentication needed for a future transaction. The authentication key 136 can comprise a one-time use cryptographic key. The transaction criteria 139 can comprise a credential receiving entity identifier, a terminal identifier, a maximum transaction amount, an expiration date, a transaction location, and/or other data that can be associated with a transaction. When validating the pre-authentication for a given transaction, a terminal 106 can use the transaction criteria 139 to confirm that the given transaction satisfies the requirements defined by the transaction criteria 139. The risk level 142 corresponds to an issuer-defined level of risk that is placed on a merchant for approving a transaction that is based on a pre-authentication. The risk level 142 can represent for example, a low risk level, a high risk level, or a medium risk level. In some examples, the risk level 142 comprises a value that is associated with a given risk level. In various examples, once the pre-authentication data 109 is generated, the issuer service 118 can transmit the pre-authentication data 109 to the client device 103 for storage on the wallet 133 of the client device 103 for a future transaction.

Turning back to FIG. 1, the client device 103 engaging in a transaction with the terminal 106 transmits a pre-authentication transaction payload 107 based at least in part on pre-authentication data 109 and transaction data 112 when engaging in a transaction. In some examples, the pre-authentication transaction payload 107 transferred to the terminal 106 includes an authentication cryptogram generated based at least in part on the transaction criteria 139, the risk level 142, and/or the pre-authentication key 136. In some example, the pre-authentication transaction payload 107 can include the transaction criteria 139 and/or the risk level 142 that are digitally signed by the pre-authentication key 136. In some examples, the pre-authentication data 109 can be embedded in the transaction data 112. For example, the pre-authentication transaction payload 107 can comprise the transaction data 112 in a form of a cryptogram, and a cryptogram generated using the pre-authentication data 109 or the digitally signed pre-authentication data 109 can be embedded within the transaction data 112 cryptogram.

Upon receiving the pre-authentication transaction payload 107, a terminal service 145 (FIG. 2) of the terminal 106 can validate the pre-authentication represented by the pre-authentication transaction payload 107. In the example of the pre-authentication being represented by a cryptogram, the terminal service 145 can generate another cryptogram based at least in part on the transaction criteria 139 and/or risk level 142 and an issuer authentication key 148 (FIG. 2) that is issued to the terminal 106 from the issuer and derived using a master key 151 (FIG. 2) held by the issuer. The pre-authentication key 136 that is provided to the client device 103 and used to generate the pre-authentication cryptogram included in pre-authentication transaction payload 107 is also derived by the master key 151. Accordingly, the terminal service 145 can compare the cryptogram it generated with the pre-authentication cryptogram included in the pre-authentication transaction payload 107. If there is a match, the terminal service 145 can validate the pre-authentication.

In other examples, the terminal service 145 can further validate the pre-authentication by comparing the transaction criteria 139 associated with the pre-authentication with factors associated with the transaction. For example, the transaction criteria 139 can comprise a credential receiving entity identifier, a terminal identifier, a maximum transaction amount, an expiration date, a transaction location, and/or other data that can be associated with a transaction. The terminal service 145 can determine whether the transaction criteria 139 is satisfied for the current transaction as an additional validation step.

In some examples, the terminal service 145 can compare the risk level 142 included in the pre-authentication transaction payload 107 to determine if the terminal service 145 is willing to accept or deny the transaction. For example, the terminal service 145 can compare the risk level 142 with one or more other types of factors, such as, for example, the type of transaction, the amount of the transaction, the user associated with the transaction, the time of the transaction, and/or other factors to determine if the transaction should be approved or denied based at least in part on the risk level. 142. Once the terminal service 145 approves or denies the application, the terminal service 145 can notify the client device 103 and the client device 103 can in turn notify the issuer service 118 of the approval or denial of the transaction when the client device 103 returns to online mode or is otherwise able to communicate with the issuer service 118.

With reference to FIG. 2, shown is a network environment 200 according to various embodiments. The network environment 200 can include a computing environment 203, a client device 103, and a terminal 106, which can be in data communication with each other via a network 206.

The network 206 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 206 can also include a combination of two or more networks 206. Examples of networks 206 can include the Internet, intranets, extranets, virtual private networks (VPNs), and similar networks.

The computing environment 203 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 203 can employ a plurality of computing devices that can be arranged in one or more server banks or computer banks or other arrangements. Such computing devices can be located in a single installation or can be distributed among many different geographical locations. For example, the computing environment 203 can include a plurality of computing devices that together can include a hosted computing resource, a grid computing resource or any other distributed computing arrangement. In some cases, the computing environment 203 can correspond to an elastic computing resource where the allotted capacity of processing, network, storage, or other computing-related resources can vary over time.

Various applications or other functionality can be executed in the computing environment 203. The components executed on the computing environment 203 include an issuer service 118, and other applications, services, processes, systems, engines, or functionality not discussed in detail herein.

The issuer service 118 can interact with a client application 209 and/or a wallet application 212 on a client device 103 to provide backend functionality for the client application 209 and/or the wallet application 212. For example, the issuer service 118 can interact with the client application 209 and/or the wallet application 212 to provide security services (e.g., authorization and authentication services needed by the client application 209 and/or the wallet application 212 to perform various tasks), provide data synchronization across multiple devices and platforms, and/or other operations.

In various examples, the issuer service 118 can identify a future transaction requiring authentication based at least in part on a behavior pattern of the user and/or on a pre-authentication request received from the client device 103 in response to user interactions with a user interface 124 rendered on the client device 103. In one example, a user interacting with a user interface 124 associated with the issuer service 118 and rendered on the client device 103 can request pre-authentication for a future transaction. In this example, the pre-authentication request can include details associated with the request including a merchant identifier, an expected transaction amount, an expected transaction date/time, and/or other data.

In some examples, the issuer service 118 can analyze historical data (e.g., user spend behavior at given terminals 106, dispute data associated with merchants, terminals 106, users, etc.), geolocation, time-bound wallet passes (e.g., event tickets, etc.) to assess behavior patterns that can be used to validate reliability and a need for pre-fetched authentication. In some examples, the historical data can include user data 127 and device data 130 received from the client device 103 that can be used identify behavior patterns of the user that may indicate a future transaction and corresponding risk. For example, a behavior pattern can indicate that after a user visits a first store, they typically visit a coffee shop to purchase coffee. As such, the future transaction can correspond to the coffee purchase at the second store. In another example, the issuer service 118 can detect future transactions based at least in part on a scheduled event.

In some examples, the issuer service 118 can analyze the historical data using trained pattern detection model 215. For example, the issuer service 118 can generate input data based at least in part on the historical data. Upon generating the input data, the issuer service 118 can apply the inputs to the trained pattern detection model 215. The output of the trained pattern detection model 215 can include a prediction of a future transaction. In some examples, the output can further include a risk level 142 associated with the future transaction. In some examples, the issuer service 118 can analyze the historical data periodically. In other examples, the issuer service 118 can analyze the historical data based at least in part on a need, such as, for example, a scheduled event (e.g., detection of a time-bound pass in a user wallet 133 (FIG. 2)), a pre-authentication request, and/or other type of future transaction indicator.

In various examples, the issuer service 118 can identify a risk level 142 associated with the future transaction and corresponding pre-authentication. For example, the issuer service 118 can analyze the user data 127, device data 130, and/or other data to determine a level of risk that is placed on a credential receiving entity (e.g., merchant, access provider, etc.) for approving a transaction that is based on a pre-authentication when the client device 103 is offline. As such, the credential receiving entity, via the corresponding terminal 106, can determine whether to approve and/or deny a transaction with a client device 103 based at least in part on the risk level and proof of pre-authentication. In some examples, the risk level 142 is included in the output of the pattern detection model 215. In other examples, factors associated with the future transaction (e.g., predicted transaction amount, predicted transaction time, predicted merchant, predicted terminal, etc.) can be assigned weights. The sum of the weights can be used to determine a risk level. For example, if the sum of the weights is within a threshold range for a low risk level 142, the risk level 142 will be determined to be low.

In various examples, the issuer service 118 can generate pre-authentication data 109 that is associated with a given terminal 106 and/or credential receiving entity (e.g., merchant) in response to predicting or otherwise identifying a future transaction. The pre-authentication data 109 can include an authentication key 136, transaction criteria 139, a risk level 142, and/or other data associated with the pre-authentication needed for a future transaction. The authentication key 136 can comprise a one-time use cryptographic key and can be derived from a master key 151 held by the issuer. The transaction criteria 139 can comprise a credential receiving entity identifier, a terminal identifier, a maximum transaction amount, an expiration date, a transaction location, and/or other data that can be associated with a transaction. When validating the pre-authentication for a given transaction, a terminal 106 can use the transaction criteria 139 to confirm that the given transaction satisfies the requirements defined by the transaction criteria 139. The risk level 142 corresponds to an issuer-defined level of risk that is placed on a merchant for approving a transaction that is based on a pre-authentication. The risk level 142 can represent for example, a low risk level, a high risk level, or a medium risk level. In some examples, the risk level 142 comprises a value that is associated with a given risk level.

In various examples, once the pre-authentication data 109 is generated, the issuer service 118 can transmit the pre-authentication data 109 to the client device 103 for storage on the wallet 133 of the client device 103 for a future transaction. Upon the occurrence of the future transaction, the issuer service 118 can receive feedback data 218 from the client device 103 via the client application 209 and/or the wallet application 212. The feedback data 218 can indicate whether the terminal 106 approved or denied the transaction. In various examples, the issuer service 118 can retrain the pattern detection model 215 based at least in part on the feedback data 218 associated with the pre-authentication data 109.

In some examples, the issuer service 118 can be executed to provision terminals 106 to accept payments using credentials issued by the issuer. The issuer service 118 can receive pending transaction data with an authorization request for a given transaction from the terminal 106. Using the pending transaction data included in an authorization request, the issuer service 118 can confirm that funds or credit is available for a given payment instrument, such that the payment transaction is authorized to proceed or not authorized to proceed.

Also, various data is stored in a computing environment data store 220 that is accessible to the computing environment 203. The computing environment data store 220 can be representative of a plurality of computing environment data store 220, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the computing environment data store 220 is associated with the operation of the various applications or functional entities described below. This data can include user data 127, device data 130, a master key 151, a pattern detection model 215, feedback data 218, pre-authentication rules 221, and potentially other data.

The user data 127 can represent data related to users having accounts with the organization or enterprise associated with the computing environment 203. For example, the user data can correspond to information related to individuals who have been issued payment accounts by an issuer associated with the issuer system. A payment account can represent any financial account or agreement that a customer can use as a source of funds for payments. Payment accounts can include both credit accounts or facilities and financial deposit accounts that provide the owner with on demand access to funds stored in or associated with the payment account. In some instances, a payment account can allow a user to have frequent and/or immediate access to funds. In these instances, payment accounts can also be referred to as demand deposit accounts, which can be accessed in a variety of ways, such as the use of debit cards, checks, or electronic transfers (e.g., wire transfer, automated clearing house (ACH) transfer, real-time payment (RTP) networks such as FedNow or The Clearinghouse (TCH), etc.). Examples of payment accounts include charge or charge card accounts, credit or credit card accounts, checking accounts, savings accounts, money market accounts, demand accounts, deposit accounts, demand deposit accounts, etc.

The user data 127 can include credential data 224, transaction history data 227, event data 230, behavior data 233, and/or other data associated with the user. The credential data 224 can include data associated with credentials issued to the user. For example, the credential data 224 can comprise data identifying payment credentials, identification credentials, access credentials, loyalty account credentials, and/or other type of data associated with a credential of a user. For example, a payment credential can comprise data describing credit cards, debit cards, virtual cards, charge cards, and/or other mechanisms for effecting a payment with respect to a transaction account provided by the issuer and associated with the user of the client device 103. For example, for a credit card or a charge card, the payment credential can store a card number, a cardholder name, an expiration date, a verification code, a billing address, and/or other information needed to consummate a payment. An identification credential can be used to verify personal information about a user such as, for example, a user name, date of birth, address, photograph, identification number, biometric data, physical characteristics, and/or other type of personal information. An access credential can be used to grant the user access to a specific location. The access credential can comprise user information, access level, credential type, issuing authority, expiration data, and/or other types of information.

The credential data 224 can further comprise pre-authentication data 109 associated with a pre-authentication of a future transaction for the given credential. The pre-authentication data 109 can include an authentication key 136, transaction criteria 139, a risk level 142, and/or other data associated with the pre-authentication needed for a future transaction. The authentication key 136 can comprise a one-time use cryptographic key derived from the master key 151. The transaction criteria 139 can comprise a credential receiving entity identifier, a terminal identifier, a maximum transaction amount, an expiration date, a transaction location, and/or other data that can be associated with a transaction. When validating the pre-authentication for a given transaction, a terminal 106 can use the transaction criteria 139 to confirm that the given transaction satisfies the requirements defined by the transaction criteria 139. The risk level 142 corresponds to an issuer-defined level of risk that is placed on a merchant for approving a transaction that is based on a pre-authentication. The risk level 142 can represent for example, a low risk level, a high risk level, or a medium risk level. In some examples, the risk level 142 comprises a value that is associated with a given risk level.

The transaction history data 227 includes transaction data associated with prior transactions associated with any one of the user credentials represented by the credential data 224. In the example of a payment transaction, the transaction history data 227 can include a transaction amount, a transaction merchant, industry identification data associated with the transaction, transaction time, transaction date, transaction authentication mode, transaction mode, transaction location information, network connectivity data, device data, user account data, and/or other attributes associated with a given transaction.

The event data 230 can represent data corresponding to events associated with the user. For example, the event data 230 can include calendar data, ticket data, registration data, and/or other type of information associated with an event. The event data 230 can include a type of event, a date of the event, a location of the event, and/or other type of event information.

The behavior data 233 can represent data associated with the user's behavior. For example, the behavior data 233 can include digital interactions (e.g., page views, scrolling behavior, search queries, digital purchase behavior, etc.), routine physical behaviors (e.g., where a user routinely visits), transaction behaviors (e.g., what payment card a user uses at a given store, transaction terminal mode (e.g., tap, insert, swipe, use wallet 133, etc.), loyalty engagement data, and/or other type of data that can define a user's actions in a given situation.

The device data 130 can include information about the end user client device 103. The device data 130 can include, for example, information specifying applications that are installed on the client device 103, configurations or settings that are applied to the client device 103, user accounts associated with the device 103, the physical location of the client device 103, and/or other information associated with the client device 103.

The master key 151 can represent a cryptographic symmetric key that can be used to derive subordinate keys (e.g., session keys). In some examples, the master key 151 is unique to a given user and/or user account. The issuer service 118 can use the master key 151 to derive the pre-authentication key 126 when permitting a pre-authentication of a future transaction. Likewise, the issuer service 118 can use the master key 151 to derive the issuer authentication key 148 that is provided to a terminal 106 for validation of a pre-authenticated transaction.

The pattern detection model 215 can include, for example, a logistic regression classifier, a random forest classifier, a decision tree classifier, a XGBoost classifier, a multi-layer perceptron classifier, a recurrent neural network, a feed-forward neural network, a label-specific attention network, and/or any other type of trained model as can be appreciated. According to various examples, the pattern detection model 215 can be trained historical data to analyze input data (e.g., user interaction data, loyalty engagement data, user data, geolocation, event or calendar data, card benefits, terminal data, credential data, terminal data, issuer data, etc.) to make an informed prediction of user behavior and any future transactions. In addition, the pattern detection model 215 can be trained to output risk levels 142 associated with accepting a transaction that has been pre-authenticated.

The feedback data 218 can include data that indicates whether the terminal 106 approved or denied a transaction that was pre-authenticated. In various examples, the issuer service 118 can retrain the pattern detection model 215 based at least in part on the feedback data 218 associated with the pre-authentication data 109.

The pre-authentication rules 221 can include rules, models, and/or configuration data for the various algorithms or approaches employed by the issuer service 118 for detecting a future transaction and pre-authenticating the future transaction. For example, the pre-authentication rules 221 can include rules for generating the transaction criteria 139 that is included in the pre-authentication data 109 for a given pre-authentication based at least in part on one or more factors associated with the future transaction (e.g., predicted transaction amount, predicted transaction location, predicted merchant, etc.). In other examples, the pre-authentication rules 221 can include weights and threshold values that are used by the issuer service 118 to generate a risk level 142. The pre-authentication rules 221 can further be used to define how often the issuer service 118 analyzes historical data and what types of historical data are used to predict a future transaction requiring pre-authentication.

The terminal 106 can represent a transaction system that can include a corresponding computer system or computing device with a processor and a memory. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), a payment terminal, an access terminal, a point of sale (PoS) system, or other devices with like capability.

In various examples, the terminal 106 can accept direct wireless communications (e.g., NFC, Bluetooth, etc.) for communicating with a client device 103. For example, when a user is wanting to complete a transaction, the user could tap or otherwise place the client device 103 and/or communication device 236 of the client device 103 in an appropriate proximity to the terminal 106 to establish a direct wireless connection 115 with the terminal 106. Upon establishing a direct wireless connection 115, the client device 103 can transmit the pre-authentication transaction payload 107 the terminal 106.

Various applications or other functionality can be executed by the terminal 106 according to various embodiments. The components executed on a transaction terminal 106 can include a terminal service 145, and other applications, services, processes, systems, engines, or functionality not discussed in detail herein.

In various examples, the terminal service 145 can receive the pre-authentication transaction payload 107 comprising the transaction data 112 and authentication at least in part on the pre-authentication data 109 from a client device 103 and can validate the pre-authentication. In various examples, the authentication can be represented by transaction criteria 139, a risk level 142, and an authentication cryptogram. In other examples, the authentication can be represented by transaction criteria 139, a risk level 142, and a digital signature of the transaction criteria 139 and/or risk level 142. In some example, the authentication does not include a risk level 142.

When the pre-authentication transaction payload 107 includes a pre-authentication cryptogram, the terminal service 145 can generate another cryptogram based at least in part on the transaction criteria 139 and/or risk level 142 and an issuer authentication key 148 that is issued to the terminal 106 from the issuer and derived using a master key 151 held by the issuer. The pre-authentication key 136 that is provided to the client device 103 and used to generate the pre-authentication cryptogram data 109 is also derived by the master key 151. Accordingly, the terminal service 145 can compare the cryptogram it generated with the pre-authentication cryptogram included in the pre-authentication transaction payload 107. If there is a match, the terminal service 145 can validate the pre-authentication associated with the transaction. In the example where the authentication comprises digital signatures, the digital signature can be validated to validate the pre-authentication.

In some examples, the terminal service 145 can further validate the pre-authentication comparing the transaction criteria 139 associated with the pre-authentication with factors associated with the transaction. For example, the transaction criteria 139 can comprise a credential receiving entity identifier, a terminal identifier, a maximum transaction amount, an expiration date, a transaction location, and/or other data that can be associated with a transaction. The terminal service 145 can determine whether the transaction criteria 139 is satisfied for the current transaction as an additional validation step.

In some examples, the terminal service 145 can compare the risk level 142 included in the pre-authentication transaction payload 107 to determine if the terminal service 145 is willing to accept or deny the transaction. For example, the terminal service 145 can compare the risk level 142 with one or more other types of factors, such as, for example, the type of transaction, the amount of the transaction, the user associated with the transaction, the time of the transaction, and/or other factors to determine if the transaction should be approved or denied based at least in part on the risk level 142. Once the terminal service 145 approves or denies the application, the terminal service 145 can notify the client device 103 and the client device 103 can in turn notify the issuer service 118 of the approval or denial of the transaction when the client device 103 returns to online mode or is otherwise able to communicate with the issuer service 118.

Also, various data is stored in the terminal data store 239 that is accessible to the client device 103. The terminal data store 239 can be representative of a plurality of data stores as can be appreciated. The data stored in the terminal data store 239, for example, is associated with the operation of various applications and/or functional entities described herein. The terminal data store 239 can store an issuer authentication key 148, risk level rules 242 and other data as can be appreciated.

The issuer authentication key 148 can comprise a cryptographic key that is derived from the master key 151 of the entity associated with the computing environment 203. The issuer authentication key 148 can be used by the terminal service 145 to validate the pre-authentication included in the pre-authentication transaction payload 107 that is received from the client device 103. For example, the issuer authentication key 148 can be derived from the same master key 151 as the pre-authentication key 136 that is used to sign the transaction criteria 139 and/or cryptogram associated with the transaction criteria 138.

The risk level rules 242 can include rules, models, and/or configuration data for the various algorithms or approaches employed by the terminal service 145 when determining whether to approve or deny a transaction that has been pre-authenticated. For example, the terminal service 145 can compare the risk level 142 with one or more other types of factors, such as, for example, the type of transaction, the amount of the transaction, the user associated with the transaction, the time of the transaction, and/or other factors to determine if the transaction should be approved or denied based at least in part on the risk level. 142. The factors and any threshold levels can be defined by the risk level rules 242.

The client device 103 is representative of a plurality of client devices that can be coupled to the network 206. The client device 103 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 103 can include one or more displays 245, such as liquid crystal displays (LCDs), gas plasma-based flat panel displays, organic light emitting diode (OLED) displays, electrophoretic ink (“E-ink”) displays, projectors, or other types of display devices. In some instances, the display 245 can be a component of the client device 103 or can be connected to the client device 103 through a wired or wireless connection.

The client device 103 can be configured to execute various applications such as a client application 209, a wallet application 212, or other applications. The client application 209 can be executed in a client device 103 to access network content served up by the computing environment 203 or other servers, thereby rendering a user interface 124 on the display 245. To this end, the client application 209 can include a browser, a dedicated application, or other executable, and the user interface 124 can include a network page, an application screen, or other user mechanism for obtaining user input. The client device 103 can be configured to execute applications beyond the client application 209 such as email applications, social networking applications, word processors, spreadsheets, or other applications.

The wallet application 212 can be executed to monitor and send context data to the issuer service 118. The context data can comprise transaction data 112, device data 130, and/or other data. The context data can be transmitted periodically, in response to a detected event (e.g., event ticket added to the wallet 133, a transaction, etc.), and/or a scheduled time. The wallet application 212 can further be executed to generate and send pre-authentication requests to the issuer service 118 in response to a user interacting with a user interface 124 rendered on the client device. For example, when a user is aware of a future transaction that may require pre-authentication, the user can interact with the user interface 124 to define parameters of the future transaction. The pre-authentication request can include transaction details about the transaction including, for example, an estimated transaction amount, a transaction location, a transaction date, a transaction time, a merchant, a terminal identifier, and/or other factors about the transaction.

The wallet application 212 can obtain pre-authentication data 109 from the issuer service 118 in response to the issuer service 118 identifying a future transaction. The pre-authentication data 109 can be associated with a given credential and future transaction and can include an authentication key 136, transaction criteria 139, a risk level 142, and/or other data associated with the pre-authentication needed for a future transaction. The authentication key 136 can comprise a one-time use cryptographic key and can be derived from a master key 151 held by the issuer. The transaction criteria 139 can comprise a credential receiving entity identifier, a terminal identifier, a maximum transaction amount, an expiration date, a transaction location, and/or other data that can be associated with a transaction. The risk level 142 corresponds to an issuer-defined level of risk that is placed on a merchant for approving a transaction that is based on a pre-authentication. The risk level 142 can represent for example, a low risk level, a high risk level, or a medium risk level. In some examples, the risk level 142 comprises a value that is associated with a given risk level. The wallet application 212 can store the pre-authentication data 109 in association with the credential until the occurrence of the future transaction.

In various examples, the wallet application 212 can receive a request to establish a direct wireless connection 115 with a terminal 106. In some examples, the wallet application 212 can receive the request in response to the user tapping or otherwise placing the client device 103 in an appropriate proximity to the terminal 106 to establish a direct wireless connection 115. In some examples, the user can interact with a user interface 124 associated with the wallet application 212 and request via the interactions to establish the direct wireless connection 115.

In some examples, once the direct wireless connection 115 is established with the terminal 106, the wallet application 212 can receive transaction details associated with the transaction such as, for example, a transaction amount, a terminal identifier, a merchant identifier, and/or other data. In various examples, the wallet application 212 can generate the pre-authentication transaction payload 107 to provide to terminal 106 for the given transaction based at least in part on the transaction details received from the terminal 106. The pre-authentication transaction payload 107 can comprise a payload including transaction data 112, credential data 224, and an authentication that based at least in part on the pre-authentication data 109. In some examples, the wallet application 212 generates a first cryptogram associated with the pre-authentication data 109. In various example, the first cryptogram can represent an authentication token for the transaction. The first cryptogram can be generated based at least in part on the transaction criteria 139, the risk level, 142, and any other authentication data. In other examples, the wallet application 212 can use the pre-authentication key 136 to digitally sign the transaction criteria 139 and/or risk level 142 to thereby represent the pre-authentication. The wallet application 212 can future generate a second cryptogram including the transaction data 112 and the pre-authentication data 109 that is prepared by the wallet application 212 for transition. In some example, the prepared-authentication data 109 is embedded in the second cryptogram. For example, the first cryptogram comprising the pre-authentication data 109 can be embedded in the transaction data 112 to generate the pre-authentication transaction payload 107. The wallet application 212 via the communication device 236 can transmit the pre-authentication transaction payload 107 to the terminal 106.

In some examples, the pre-authentication transaction payload 107 can be generated to be compliant with transfer standards of the direct wireless connection 115. For example, if the direct wireless connection 115 is a near-field communication (NFC) connection, the pre-authentication transaction payload 107 can an ISO7816 compliant and/or other NFC compliant tag that is generated to represent the credential to be transferred for the transaction.

In various example, the wallet application 212 can receive feedback data 218 from the terminal 106 indicating whether the terminal approved or denied the transaction. In response to receiving the feedback data 218 and upon the client device 103 being in an online mode or otherwise in connection with the computing environment 203, the wallet application 212 can transmit the feedback data 218 to the issuer service 118.

Also, various data is stored in the client data store 248 that is accessible to the client device 103. The client data store 248 can be representative of a plurality of data stores as can be appreciated. The data stored in the client data store 248, for example, is associated with the operation of various applications and/or functional entities described herein. The client data store 248 can store transaction data 112, device data 130, feedback data 218, a wallet 133, and other data as can be appreciated.

The transaction data 112 included data associated with a transaction. This data can include a date, a time, a location, transaction items, transaction amount, transaction credential, transaction terminal 106, transaction merchant, and/or other data about the transaction.

The device data 130 can include information about the end user client device 103. The device data 130 can include, for example, information specifying applications that are installed on the client device 103, configurations or settings that are applied to the client device 103, user accounts associated with the device 103, the physical location of the client device 103, and/or other information associated with the client device 103.

The feedback data 218 can include data that indicates whether the terminal 106 approved or denied a transaction that was pre-authenticated. In various examples, the issuer service 118 can retrain the pattern detection model 215 based at least in part on the feedback data 218 associated with the pre-authentication data 109.

The wallet 133 is associated with the wallet application 212 and corresponds to a digital credential wallet for securely storing credentials and associated credential data 224 of the user. For example, the credential data 224 can comprise data identifying payment credentials, identification credentials, access credentials, loyalty account credentials, and/or other type of data associated with a credential of a user. In various examples, the credential data 224 can further comprise pre-authentication data 109 associated with a pre-authentication of a future transaction for the given credential. The pre-authentication data 109 can include an authentication key 136, transaction criteria 139, a risk level 142, and/or other data associated with the pre-authentication needed for a future transaction. The authentication key 136 can comprise a one-time use cryptographic key derived from the master key 151. The transaction criteria 139 can comprise a credential receiving entity identifier, a terminal identifier, a maximum transaction amount, an expiration date, a transaction location, and/or other data that can be associated with a transaction. When validating the pre-authentication for a given transaction, a terminal 106 can use the transaction criteria 139 to confirm that the given transaction satisfies the requirements defined by the transaction criteria 139. The risk level 142 corresponds to an issuer-defined level of risk that is placed on a merchant for approving a transaction that is based on a pre-authentication. The risk level 142 can represent for example, a low risk level, a high risk level, or a medium risk level. In some examples, the risk level 142 comprises a value that is associated with a given risk level.

In addition, the wallet 133 can store one or more pre-authorization transaction payloads 107 associated with a transaction with a terminal 106. The pre-authentication transaction payload 107 can comprise a payload including transaction data 112, credential data 224, and an authentication that based at least in part on the pre-authentication data 109. In some examples, the pre-authentication transaction payload 107 transferred to the terminal 106 includes an authentication cryptogram generated based at least in part on the transaction criteria 139, the risk level 142, and/or the pre-authentication key 136. In some example, the pre-authentication transaction payload 107 can include the transaction criteria 139 and/or the risk level 142 that are digitally signed by the pre-authentication key 136. In some examples, the pre-authentication data 109 can be embedded in the transaction data 112. For example, the pre-authentication transaction payload 107 can comprise the transaction data 112 in a form of a cryptogram, and a cryptogram generated using the pre-authentication data 109 or the digitally signed pre-authentication data 109 can be embedded within the transaction data 112 cryptogram.

In various examples, the client device 103 can include a communication device 236 which can either be integrated within the client device 103 and/or in data communication with the client device 103. The communication device 236 can include a device that uses protocol standards to establish a direct wireless connection 115 with other devices with similar or like capability. For example, the communication device 236 can comprise an NFC device that uses NFC protocols to establish NFC peer-to-peer connections for exchanging data wirelessly via an NFC protocol to another devices with similar or like capability. For example, the wallet application 212 can interact with the communication device 236 to transfer the pre-authentication transaction payload 107 to a terminal 106 in response to the communication device 236 establishing a direct wireless connection 115 with the terminal 106.

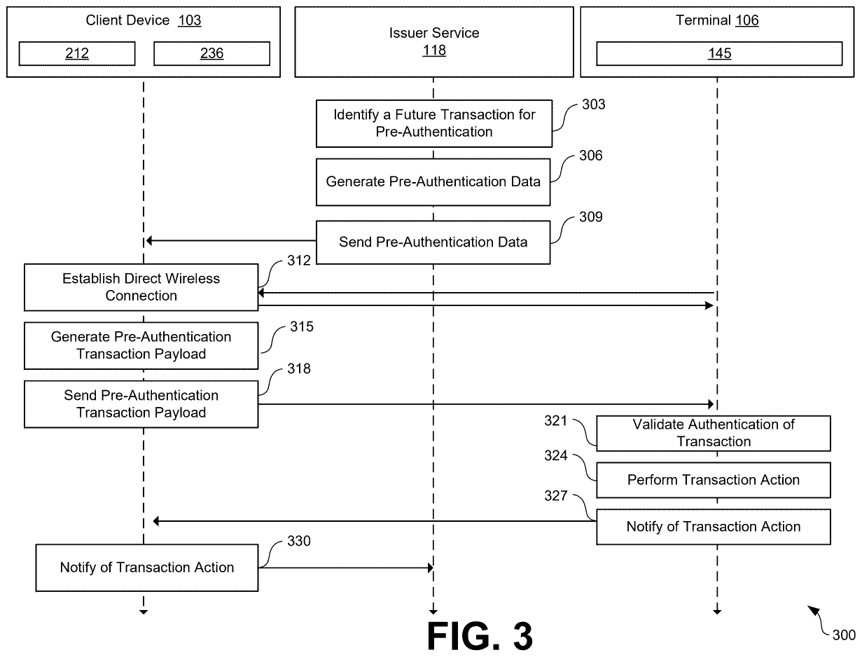

Referring next to FIG. 3, shown is a sequence diagram 300 depicting the interactions between the various components of the network environment 200 according to various embodiments of the present disclosure. The sequence diagram of FIG. 3 is intended to illustrate how an issuer service 118 can provide pre-authentication for a future predicted transaction. As an alternative, the sequence diagram 300 of FIG. 3 can be viewed as depicting an example of elements of a method implemented within the network environment 200.

At block 303, the issuer service 118 can identify a future transaction for pre-authentication. In various examples, the issuer service 118 can identify a future transaction requiring authentication based at least in part on a behavior pattern of the user and/or on a pre-authentication request received from the client device 103 in response to user interactions with a user interface 124 rendered on the client device 103. In one example, a user interacting with a user interface 124 associated with the issuer service 118 and rendered on the client device 103 can request pre-authentication for a future transaction. In this example, the pre-authentication request can include details associated with the request including a merchant identifier, an expected transaction amount, an expected transaction date/time, and/or other data. The issuer service 118 can receive the pre-authentication request from the client device.

In some examples, the issuer service 118 can analyze historical data (e.g., user spend behavior at given terminals 106, dispute data associated with merchants, terminals 106, users, etc., geolocation, time-bound wallet passes (e.g., event tickets, etc.)) to assess behavior patterns that can be used to validate reliability and a need for pre-fetched authentication. In some examples, the historical data can include user data 127 and device data 130 received from the client device 103 that can be used identify behavior patterns of the user that may indicate a future transaction and corresponding risk. For example, a behavior pattern can indicate that after a user visits a first store, they typically visit a coffee shop to purchase coffee. As such, the future transaction can correspond to the coffee purchase at the second store. In another example, the issuer service 118 can detect future transactions based at least in part on a scheduled event.

In some examples, the issuer service 118 can analyze the historical data using trained pattern detection model 215. For example, the issuer service 118 can generate input data based at least in part on the historical data. Upon generating the input data, the issuer service 118 can apply the inputs to the trained pattern detection model 215. The output of the trained pattern detection model 215 can include a prediction of a future transaction. In some examples, the output can further include a risk level 142 associated with the future transaction. In some examples, the issuer service 118 can analyze the historical data periodically. In other examples, the issuer service 118 can analyze the historical data based at least in part on a need, such as, for example, a scheduled event (e.g., detection of a time-bound pass in a user wallet 133 (FIG. 2)), a pre-authentication request, and/or other type of future transaction indicator.

At block 306, the issuer service 118 can generate pre-authentication data 109. The pre-authentication data 109 can include an authentication key 136, transaction criteria 139, a risk level 142, and/or other data associated with the pre-authentication needed for a future transaction. The authentication key 136 can comprise a one-time use cryptographic key and can be derived from a master key 151 held by the issuer. The transaction criteria 139 can comprise a credential receiving entity identifier, a terminal identifier, a maximum transaction amount, an expiration date, a transaction location, and/or other data that can be associated with a transaction. When validating the pre-authentication for a given transaction, a terminal 106 can use the transaction criteria 139 to confirm that the given transaction satisfies the requirements defined by the transaction criteria 139. The risk level 142 corresponds to an issuer-defined level of risk that is placed on a merchant for approving a transaction that is based on a pre-authentication. The risk level 142 can represent for example, a low risk level, a high risk level, or a medium risk level. In some examples, the risk level 142 comprises a value that is associated with a given risk level.

At block 309, the issuer service 118 can send the pre-authentication data 109 to the client device 103 for storage on the wallet 133 of the client device 103 for a future transaction. For example, the issuer service 118 can send the pre-authentication data 109 to the wallet application 212 of the client device 103 over the network 206. In some examples, the issuer service 118 can send pre-authentication data 109 associated with multiple future predicted transactions periodically. In other examples, the issuer service 118 sends the pre-authentication data 109 in response to identifying the future transaction and generating the pre-authentication data 109.

At block 312, the wallet application 212 via the communication device 236 can establish a direct wireless connection 115 with a terminal 106. For example, when a user is wanting to complete a transaction, the user could tap or otherwise place the client device 103 and/or communication device 236 of the client device 103 in an appropriate proximity to the terminal 106 to establish a direct wireless connection 115 with the terminal 106. In some examples, once the direct wireless connection 115 is established with the terminal 106, the wallet application 212 can receive transaction details associated with the transaction such as, for example, a transaction amount, a terminal identifier, a merchant identifier, and/or other data.

At block 315, the wallet application 212 can generate a pre-authentication transaction payload 107. The pre-authentication transaction payload 107 can comprise a payload including transaction data 112, credential data 224, and an authentication that based at least in part on the pre-authentication data 109. In some examples, the wallet application 212 generates a first cryptogram associated with the pre-authentication data 109. In various example, the first cryptogram can represent an authentication token for the transaction. The first cryptogram can be generated based at least in part on the transaction criteria 139, the risk level, 142, and any other authentication data. In other examples, the wallet application 212 can use the pre-authentication key 136 to digitally sign the transaction criteria 139 and/or risk level 142 to thereby represent the pre-authentication. The wallet application 212 can future generate a second cryptogram including the transaction data 112 and the pre-authentication data 109 that is prepared by the wallet application 212 for transition. In some example, the prepared-authentication data 109 is embedded in the second cryptogram. For example, the first cryptogram comprising the pre-authentication data 109 can be embedded in the transaction data 112 to generate the pre-authentication transaction payload 107.

In some examples, the pre-authentication transaction payload 107 can be generated to be compliant with transfer standards of the direct wireless connection 115. For example, if the direct wireless connection 115 is a near-field communication (NFC) connection, the pre-authentication transaction payload 107 can an ISO7816 compliant and/or other NFC compliant tag that is generated to represent the credential to be transferred for the transaction.

At block 318, the wallet application 212 via the communication device 236 can transmit the pre-authentication transaction payload 107 to the terminal 106. For example, the terminal 106 can act as a reader for the direct wireless connection 115 and is able to obtain the pre-authentication transaction payload 107 from the communication device 236 of the client device 103.

At block 321, the terminal service 145 can validate the authentication of the transaction via data included in the pre-authentication transaction payload 107. In various examples, the authentication can be represented by transaction criteria 139, a risk level 142, and an authentication cryptogram. In other examples, the authentication can be represented by transaction criteria 139, a risk level 142, and a digital signature of the transaction criteria 139 and/or risk level 142. In some example, the authentication does not include a risk level 142.

When the pre-authentication transaction payload 107 includes a pre-authentication cryptogram, the terminal service 145 can generate another cryptogram based at least in part on the transaction criteria 139 and/or risk level 142 and an issuer authentication key 148 that is issued to the terminal 106 from the issuer and derived using a master key 151 held by the issuer. The pre-authentication key 136 that is provided to the client device 103 and used to generate the pre-authentication cryptogram data 109 is also derived by the master key 151. Accordingly, the terminal service 145 can compare the cryptogram it generated with the pre-authentication cryptogram included in the pre-authentication transaction payload 107. If there is a match, the terminal service 145 can validate the pre-authentication associated with the transaction. In the example where the authentication comprises digital signatures, the digital signature can be validated to validate the pre-authentication.

In some examples, the terminal service 145 can further validate the pre-authentication comparing the transaction criteria 139 associated with the pre-authentication with factors associated with the transaction. For example, the transaction criteria 139 can comprise a credential receiving entity identifier, a terminal identifier, a maximum transaction amount, an expiration date, a transaction location, and/or other data that can be associated with a transaction. The terminal service 145 can determine whether the transaction criteria 139 is satisfied for the current transaction as an additional validation step.

In some examples, the terminal service 145 can compare the risk level 142 included in the pre-authentication transaction payload 107 to determine if the terminal service 145 is willing to accept or deny the transaction. For example, the terminal service 145 can compare the risk level 142 with one or more other types of factors, such as, for example, the type of transaction, the amount of the transaction, the user associated with the transaction, the time of the transaction, and/or other factors to determine if the transaction should be approved or denied based at least in part on the risk level 142.

At block 324, the terminal service 146 can perform a transaction action. For example, if the terminal service 145 is unable to validate the authentication, the transaction action can comprise the denial of the transaction. In some example, the terminal service 146 is able to validate the authentication, but can determine that the risk level 142 requires the terminal service 146 to deny the service. Likewise, if the terminal service 145 is able to validate the authentication, along with the determining that the transaction criteria 139 is satisfied and the risk level 142 is acceptable, the transaction action can comprise the approval of the transaction.

At block 327, the terminal service 146 can notify the client device 103 of the transaction action. For example, the terminal service 146 can send a notification indicating whether the transaction was approved or denied via the direct wireless connection 115. In some examples, the notification can include details as to why the transaction was denied or approved.

At block 330, the wallet application 212 can notify the issuer service 118 of the transaction action. In some examples, the wallet application 212 can send the notification indicating whether the transaction was approved or denied via the network 206 once a connection has been established between the client device 103 and the computing environment 203. For example, if the client device 103 was operating in an offline mode for the transaction, the client device 103 is unable to send the notification to the issuer service 118 at the time of the transaction. Thereafter, this portion of the process proceeds to completion.

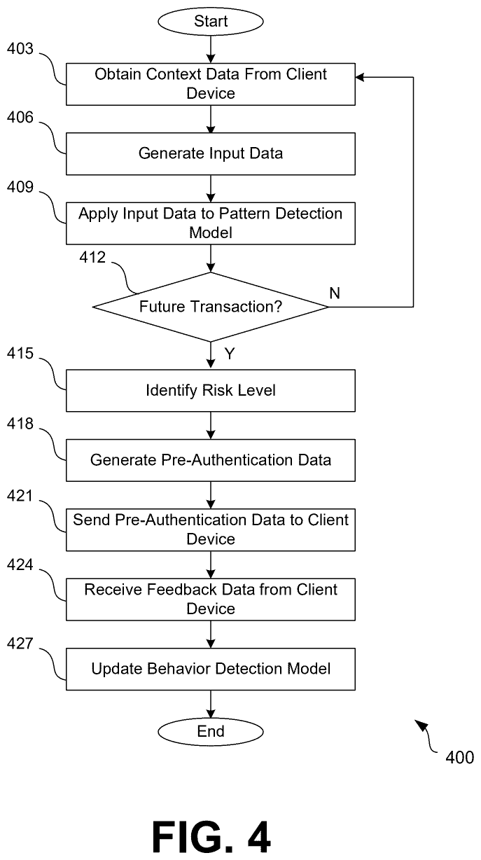

Referring next to FIG. 4, shown is a flowchart 400 that provides one example of the operation of a portion of the issuer service 118. The flowchart of FIG. 4 provides merely an example of the many different types of functional arrangements that can be employed to implement the operation of the depicted portion of the issuer service 118. As an alternative, the flowchart of FIG. 4 can be viewed as depicting an example of elements of a method implemented within the network environment 200.

Beginning with block 403, the issuer service 118 can obtain context data from a client device 103. The context data can comprise transaction data 112, device data 130, and/or other data. The context data can be obtained periodically, in response to a detected event (e.g., event ticket added to the wallet 133, a transaction, etc.), and/or a scheduled time.

At block 406, the issuer service 118 can generate input data based at least in part on the context data. In various examples, the input data can be generated according to the context data and historical data (e.g., user spend behavior at given terminals 106, dispute data associated with merchants, terminals 106, users, etc., geolocation, time-bound wallet passes (e.g., event tickets, etc.)). In various examples, the input data is generated to be in a compliant format to input into a pattern detection model 215.

At block 409 the issuer service 118 can apply the input data to a pattern detection model 215. According to various examples, the pattern detection model 215 can be trained historical data to analyze input data (e.g., user interaction data, loyalty engagement data, user data, geolocation, event or calendar data, card benefits, terminal data, credential data, terminal data, issuer data, etc.) to make an informed prediction of user behavior and any future transactions. The issuer service 118 can execute the pattern detection model 215 and apply the generated input data to the pattern detection model 215 to analyze historical data for assessing behavior patterns that can be used to validate reliability and a need for pre-fetched authentication.

At block 412, the issuer service 118 determines if there is a future transaction that requires authentication. For example, the output of the trained pattern detection model 215 can include a prediction of a future transaction. For example, the output may indicate a behavior pattern that can indicate that after a user visits a particular retail store, they typically visit a coffee shop to purchase coffee. As such, the future transaction can correspond to the coffee purchase at the second store based at least in part on the user vesting the retail store and his or her inferred behavior patterns. In another example, the output of the pattern detection model 215 can indicate one or more future transactions based at least in part on a scheduled event. For example, if a user is scheduled to attend a concert, the user's behavior patterns may indicate that the user typically buys merchandise and concessions when attending concerts.

At block 415, the issuer service 118 can identify a risk level 142. The risk level 142 corresponds to an issuer-defined level of risk that is placed on a merchant for approving a transaction that is based on a pre-authentication. The risk level 142 can represent for example, a low risk level, a high risk level, or a medium risk level. In some examples, the risk level 142 comprises a value that is associated with a given risk level. In various examples, the output of the pattern detection model 215 can further include the risk level 142 of the associated future transaction.

At block 418, the issuer service 118 can generate pre-authentication data 109. The pre-authentication data 109 can include an authentication key 136, transaction criteria 139, a risk level 142, and/or other data associated with the pre-authentication needed for a future transaction. The authentication key 136 can comprise a one-time use cryptographic key and can be derived from a master key 151 held by the issuer. The transaction criteria 139 can comprise a credential receiving entity identifier, a terminal identifier, a maximum transaction amount, an expiration date, a transaction location, and/or other data that can be associated with a transaction. When validating the pre-authentication for a given transaction, a terminal 106 can use the transaction criteria 139 to confirm that the given transaction satisfies the requirements defined by the transaction criteria 139. The risk level 142 corresponds to an issuer-defined level of risk that is placed on a merchant for approving a transaction that is based on a pre-authentication. The risk level 142 can represent for example, a low risk level, a high risk level, or a medium risk level. In some examples, the risk level 142 comprises a value that is associated with a given risk level.

At block 421, the issuer service 118 can send the pre-authentication data 109 to the client device 103 for storage on the wallet 133 of the client device 103 for a future transaction. For example, the issuer service 118 can send the pre-authentication data 109 to the wallet application 212 of the client device 103 over the network 206. In some examples, the issuer service 118 can send pre-authentication data 109 associated with multiple future predicted transactions periodically. In other examples, the issuer service 118 sends the pre-authentication data 109 in response to identifying the future transaction and generating the pre-authentication data 109.

At block 424, the issuer service 118 can receive feedback data 218 from the client device 103. The feedback data 218 can include data that indicates whether the terminal 106 approved or denied a transaction that was pre-authenticated. For example, the terminal service 146 can notify the client device 103 of the transaction action. In some examples, the notification can include details as to why the transaction was denied or approved. The issuer service 118 can receive the feedback data 218 from the client device 103 once a connection has been established between the client device 103 and the computing environment 203 via the network 206.

At block 424, the issuer service 118 can update the pattern detection model 215 using the feedback data 218. According to various examples, the pattern detection model 215 can be trained historical data to analyze input data (e.g., user interaction data, loyalty engagement data, user data, geolocation, event or calendar data, card benefits, terminal data, credential data, terminal data, issuer data, etc.) to make an informed prediction of user behavior and any future transactions. The issuer service 118 can update or otherwise retrain the pattern detection model 215 using the feedback data 218 associated with a given pre-authentication. Thereafter, this portion of the process proceeds to completion.

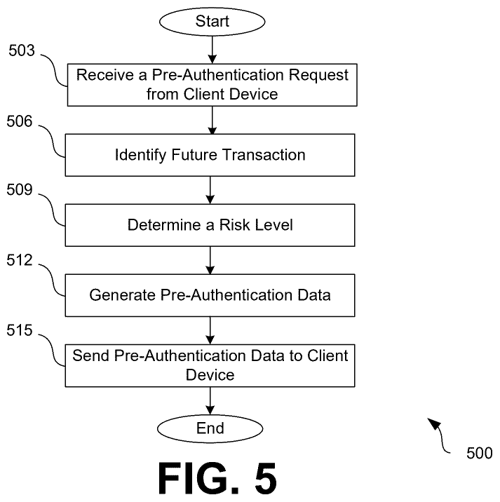

Referring next to FIG. 5, shown is a flowchart 500 that provides one example of the operation of a portion of the issuer service 118. The flowchart of FIG. 5 provides merely an example of the many different types of functional arrangements that can be employed to implement the operation of the depicted portion of the issuer service 118. As an alternative, the flowchart of FIG. 5 can be viewed as depicting an example of elements of a method implemented within the network environment 200.

Beginning with block 503, the issuer service 118 receives a pre-authentication request from a client device 103. In one example, a user interacting with a user interface 124 associated with the issuer service 118 and rendered on the client device 103 can request pre-authentication for a future transaction. In this example, the pre-authentication request can include details associated with the request including a merchant identifier, an expected transaction amount, an expected transaction date/time, and/or other data.

At block 506, the issuer service 118 can identify a future transaction. In some examples, the issuer service can identify the future transaction based at least in part on the details included in the pre-authorization request. In other examples, the issuer service 118 can generate input data based at least in part on the details included in the pre-authorization request and apply the input data to the pattern detection model 215 to determine a likelihood of the future transaction.

At block 509, the issuer service 118 can identify a risk level 142 associated with the future transaction and corresponding pre-authentication. For example, the issuer service 118 can analyze the user data 127, device data 130, and/or other data to determine a level of risk that is placed on a credential receiving entity (e.g., merchant, access provider, etc.) for approving a transaction that is based on a pre-authentication when the client device 103 is offline. As such, the credential receiving entity, via the corresponding terminal 106, can determine whether to approve and/or deny a transaction with a client device 103 based at least in part on the risk level and proof of pre-authentication. In some examples, the risk level 142 is included in the output of the pattern detection model 215. In other examples, factors associated with the future transaction (e.g., predicted transaction amount, predicted transaction time, predicted merchant, predicted terminal, etc.) can be assigned weights. The sum of the weights can be used to determine a risk level. For example, if the sum of the weights is within a threshold range for a low risk level 142, the risk level 142 will be determined to be low.

At block 512, the issuer service 118 can generate pre-authentication data 109. The pre-authentication data 109 can include an authentication key 136, transaction criteria 139, a risk level 142, and/or other data associated with the pre-authentication needed for a future transaction. The authentication key 136 can comprise a one-time use cryptographic key and can be derived from a master key 151 held by the issuer. The transaction criteria 139 can comprise a credential receiving entity identifier, a terminal identifier, a maximum transaction amount, an expiration date, a transaction location, and/or other data that can be associated with a transaction. When validating the pre-authentication for a given transaction, a terminal 106 can use the transaction criteria 139 to confirm that the given transaction satisfies the requirements defined by the transaction criteria 139. The risk level 142 corresponds to an issuer-defined level of risk that is placed on a merchant for approving a transaction that is based on a pre-authentication. The risk level 142 can represent for example, a low risk level, a high risk level, or a medium risk level. In some examples, the risk level 142 comprises a value that is associated with a given risk level.

At block 515, the issuer service 118 can send the pre-authentication data 109 to the client device 103 for storage on the wallet 133 of the client device 103 for a future transaction. For example, the issuer service 118 can send the pre-authentication data 109 to the wallet application 212 of the client device 103 over the network 206. In some examples, the issuer service 118 can send pre-authentication data 109 associated with multiple future predicted transactions periodically. In other examples, the issuer service 118 sends the pre-authentication data 109 in response to identifying the future transaction and generating the pre-authentication data 109. Thereafter, this portion of the process proceeds to completion.

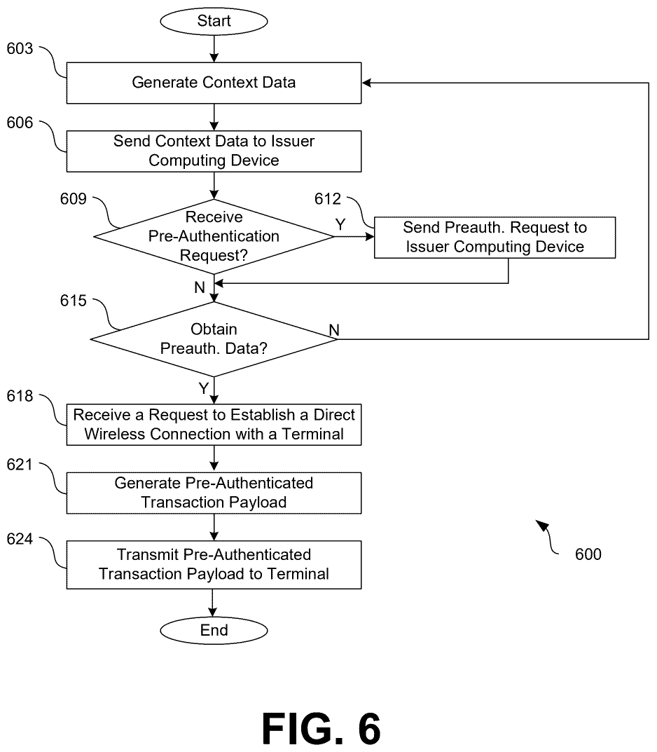

Referring next to FIG. 6, shown is a flowchart that provides one example of the operation of a portion of the wallet application 212. The flowchart of FIG. 6 provides merely an example of the many different types of functional arrangements that can be employed to implement the operation of the depicted portion of the wallet application 212. As an alternative, the flowchart of FIG. 6 can be viewed as depicting an example of elements of a method implemented within the network environment 200.

Beginning with block 603, the wallet application 212 can generate context data. The context data can comprise transaction data 112, device data 130, and/or other data. In various examples, the wallet application 212 can monitor the client device 103 and generate context data in response to a change in the transaction data 112, the device data 130, and/or other data.

At block 606, the wallet application 212 can send the context data to the issuer service 118. For example, the wallet application 212 can send the context data to the issuer service 118 via the network 206. The context data can be transmitted periodically, in response to a detected event (e.g., event ticket added to the wallet 133, a transaction, etc.), and/or a scheduled time.

At block 609, the wallet application 212 can determine if a pre-authentication request has been received. For example, when a user is aware of a future transaction that may require pre-authentication, the user can interact with the user interface 124 to define parameters of the future transaction. The pre-authentication request can include transaction details about the transaction including, for example, an estimated transaction amount, a transaction location, a transaction date, a transaction time, a merchant, a terminal identifier, and/or other factors about the transaction. If a pre-authentication request has been received via interactions with a user interface 124, the wallet application 212 can proceed to block 612 where the wallet application 212 sends the pre-authentication request to the issuer service 118 via the network 206. Otherwise, the wallet application 212 can proceed to block 615.

At block 615, the wallet application 212 can determine if pre-authentication data 109 has been obtained from the issuer service 118. The pre-authentication data 109 can be associated with a given credential and future transaction and can include an authentication key 136, transaction criteria 139, a risk level 142, and/or other data associated with the pre-authentication needed for a future transaction. The authentication key 136 can comprise a one-time use cryptographic key and can be derived from a master key 151 held by the issuer. The transaction criteria 139 can comprise a credential receiving entity identifier, a terminal identifier, a maximum transaction amount, an expiration date, a transaction location, and/or other data that can be associated with a transaction. The risk level 142 corresponds to an issuer-defined level of risk that is placed on a merchant for approving a transaction that is based on a pre-authentication. If pre-authentication data 109 has been obtained, the wallet application proceeds to block 615, otherwise, the wallet application 212 returns to block 603.

At block 618, the wallet application 212 can receive a request to establish a direct wireless connection 115 with a terminal 106. In some examples, the wallet application 212 can receive the request in response to the user tapping or otherwise placing the client device 103 in an appropriate proximity to the terminal 106 to establish a direct wireless connection 115. In some examples, the user can interact with a user interface 124 associated with the wallet application 212 and request via the interactions to establish the direct wireless connection 115. In some examples, once the direct wireless connection 115 is established with the terminal 106, the wallet application 212 can receive transaction details associated with the transaction such as, for example, a transaction amount, a terminal identifier, a merchant identifier, and/or other data.

At block 621, the wallet application 212 can generate a pre-authentication transaction payload 107. The pre-authentication transaction payload 107 can comprise a payload including transaction data 112, credential data 224, and an authentication that based at least in part on the pre-authentication data 109. In some examples, the wallet application 212 generates a first cryptogram associated with the pre-authentication data 109. In various example, the first cryptogram can represent an authentication token for the transaction. The first cryptogram can be generated based at least in part on the transaction criteria 139, the risk level, 142, and any other authentication data. In other examples, the wallet application 212 can use the pre-authentication key 136 to digitally sign the transaction criteria 139 and/or risk level 142 to thereby represent the pre-authentication. The wallet application 212 can future generate a second cryptogram including the transaction data 112 and the pre-authentication data 109 that is prepared by the wallet application 212 for transition. In some example, the prepared-authentication data 109 is embedded in the second cryptogram. For example, the first cryptogram comprising the pre-authentication data 109 can be embedded in the transaction data 112 to generate the pre-authentication transaction payload 107.

In some examples, the pre-authentication transaction payload 107 can be generated to be compliant with transfer standards of the direct wireless connection 115. For example, if the direct wireless connection 115 is a near-field communication (NFC) connection, the pre-authentication transaction payload 107 can an ISO7816 compliant and/or other NFC compliant tag that is generated to represent the credential to be transferred for the transaction.

At block 624, the wallet application 212 via the communication device 236 can transmit the pre-authentication transaction payload 107 to the terminal 106. For example, the terminal 106 can act as a reader for the direct wireless connection 115 and is able to obtain the pre-authentication transaction payload 107 from the communication device 236 of the client device 103. Thereafter, this portion of the process proceeds to completion.

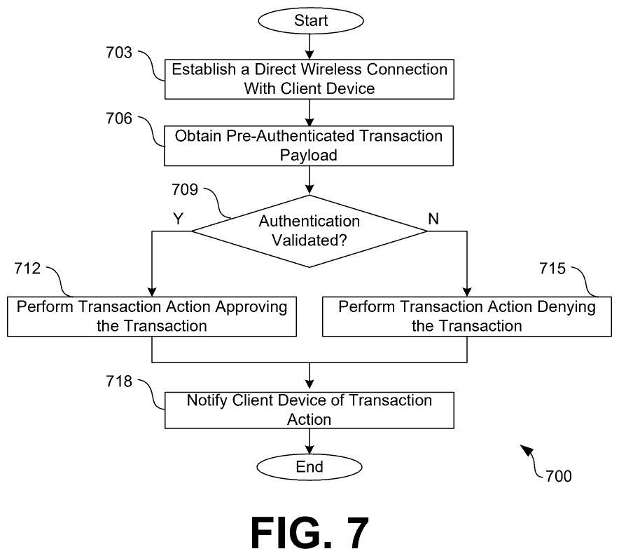

Referring next to FIG. 7, shown is a flowchart 700 that provides one example of the operation of a portion of the terminal service 145. The flowchart of FIG. 7 provides merely an example of the many different types of functional arrangements that can be employed to implement the operation of the depicted portion of the terminal service 145. As an alternative, the flowchart of FIG. 7 can be viewed as depicting an example of elements of a method implemented within the network environment 200.

Beginning with block 703, the terminal service 145 can establish a direct wireless connection 115 with a client device 103. For example, when a user is wanting to complete a transaction, the user could tap or otherwise place the client device 103 and/or communication device 236 of the client device 103 in an appropriate proximity to the terminal 106 to establish a direct wireless connection 115 with the terminal 106. In some examples, once the direct wireless connection 115 is established with the terminal 106, the terminal service 145 can send transaction details associated with the transaction to the client device 103. The transaction details can include a transaction amount, a terminal identifier, a merchant identifier, and/or other data.

At block 706, the terminal service 145 can obtain a pre-authentication transaction payload 107. The pre-authentication transaction payload 107 can comprise a payload including transaction data 112, credential data 224, and an authentication that based at least in part on the pre-authentication data 109. In various examples, the terminal 106 can act as a reader for the direct wireless connection 115 and the terminal service 145 is able to obtain the pre-authentication transaction payload 107 from the communication device 236 of the client device 103.

At block 709, the terminal service 145 can determine if the authentication included in the pre-authentication transaction payload 107 is validated. For example, the terminal service 145 can validate the authentication of the transaction via data included in the pre-authentication transaction payload 107. In various examples, the authentication can be represented by transaction criteria 139, a risk level 142, and an authentication cryptogram. In other examples, the authentication can be represented by transaction criteria 139, a risk level 142, and a digital signature of the transaction criteria 139 and/or risk level 142. In some example, the authentication does not include a risk level 142.

When the pre-authentication transaction payload 107 includes a pre-authentication cryptogram, the terminal service 145 can generate another cryptogram based at least in part on the transaction criteria 139 and/or risk level 142 and an issuer authentication key 148 that is issued to the terminal 106 from the issuer and derived using a master key 151 held by the issuer. The pre-authentication key 136 that is provided to the client device 103 and used to generate the pre-authentication cryptogram data 109 is also derived by the master key 151. Accordingly, the terminal service 145 can compare the cryptogram it generated with the pre-authentication cryptogram included in the pre-authentication transaction payload 107. If there is a match, the terminal service 145 can validate the pre-authentication associated with the transaction. In the example where the authentication comprises digital signatures, the digital signature can be validated to validate the pre-authentication.

In some examples, the terminal service 145 can further validate the pre-authentication comparing the transaction criteria 139 associated with the pre-authentication with factors associated with the transaction. For example, the transaction criteria 139 can comprise a credential receiving entity identifier, a terminal identifier, a maximum transaction amount, an expiration date, a transaction location, and/or other data that can be associated with a transaction. The terminal service 145 can determine whether the transaction criteria 139 is satisfied for the current transaction as an additional validation step.

In some examples, the terminal service 145 can compare the risk level 142 included in the pre-authentication transaction payload 107 to determine if the terminal service 145 is willing to accept or deny the transaction. For example, the terminal service 145 can compare the risk level 142 with one or more other types of factors, such as, for example, the type of transaction, the amount of the transaction, the user associated with the transaction, the time of the transaction, and/or other factors to determine if the transaction should be approved or denied based at least in part on the risk level 142. When the authentication is validated, the terminal service 145 can proceed to block 712. Otherwise, the terminal service 145 can proceed to block 715.

At block 712, the terminal service 145 can perform a transaction action approving the transaction. For example, the terminal service 145 is able to validate the authentication, along with the determining that the transaction criteria 139 is satisfied and the risk level 142 is acceptable, the transaction action can comprise the approval of the transaction.

At block 715, the terminal service 145 can perform a transaction action denying the transaction. For example, if the terminal service 145 is unable to validate the authentication, the transaction action can comprise the denial of the transaction. In some example, the terminal service 146 is able to validate the authentication, but can determine that the risk level 142 requires the terminal service 146 to deny the service.

At block 718, the terminal service 146 can notify the client device 103 of the transaction action. For example, the terminal service 146 can send a notification indicating whether the transaction was approved or denied via the direct wireless connection 115. In some examples, the notification can include details as to why the transaction was denied or approved. Thereafter, this portion of the process proceeds to completion.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts and sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts and sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts and sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 203.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

1. A system, comprising:
a computing device comprising a processor and a memory; and
machine-readable instructions stored in the memory that, when executed by the processor, cause the computing device to at least:
identify a future transaction requiring authentication, the future transaction being between a client device and a terminal;
determine a risk level associated with the future transaction;
generate pre-authentication data for the future transaction, the pre-authentication data comprising a pre-authentication key, transaction criteria, and the risk level; and
transmit the pre-authentication data to the client device.

2. The system of claim 1, wherein the machine-readable instructions further cause the computing device to at least analyze historical transaction data associated with a user to detect a behavior pattern, the future transaction being identified based at least in part on the behavior pattern.

3. The system of claim 2, wherein the system further comprises a trained pattern detection model, and the machine-readable instructions further cause the computing device to at least:
generate input data based at least in part on the historical transaction data; and
apply the input data to the trained pattern detection model, the future transaction being identified based at least in part on an output of the trained pattern detection model.

4. The system of claim 3, wherein the machine-readable instructions further cause the computing device to at least:
receive a notification from the client device indicating whether the terminal accepted or denied the future transaction with the authentication key; and
update the trained pattern detection model based at least in part on whether the terminal accepted or denied the future transaction.

5. The system of claim 1, wherein the machine-readable instructions further cause the computing device to at least:
receive a pre-authentication request for the future transaction from the client device, the future transaction being identified based at least in part on receiving the pre-authentication request, and the pre-authentication request comprising transaction details about the future transaction.

6. The system of claim 1, wherein the transaction criteria includes at least one of a merchant identifier, a maximum transaction amount, an expiration date, or a terminal identifier.

7. The system of claim 1, wherein the machine-readable instructions further cause the computing device to at least generate the pre-authentication key from a master key owned by an issuer associated with the computing device.

8-20. (canceled)

21. A method, comprising:
identifying a future transaction requiring authentication, the future transaction being between a client device and a terminal;
determining a risk level associated with the future transaction;
generating pre-authentication data for the future transaction, the pre-authentication data comprising a pre-authentication key, transaction criteria, and the risk level; and
transmitting the pre-authentication data to the client device.

22. The method of claim 21, wherein the machine-readable instructions further cause the computing device to at least analyze historical transaction data associated with a user to detect a behavior pattern, the future transaction being identified based at least in part on the behavior pattern

23. The method of claim 22, further comprising:
generating input data based at least in part on the historical transaction data; and
applying the input data to a trained pattern detection model, the future transaction being identified based at least in part on an output of the trained pattern detection model

24. The method of claim 23, further comprising:
receiving a notification from the client device indicating whether the terminal accepted or denied the future transaction with the authentication key; and
updating the trained pattern detection model based at least in part on whether the terminal accepted or denied the future transaction.

25. The method of claim 21, further comprising: receiving a pre-authentication request for the future transaction from the client device, the future transaction being identified based at least in part on receiving the pre-authentication request, and the pre-authentication request comprising transaction details about the future transaction.

26. The method of claim 21, wherein the transaction criteria includes at least one of a merchant identifier, a maximum transaction amount, an expiration date, or a terminal identifier.

27. The method of claim 21, further comprising generating the pre-authentication key from a master key owned by an issuer associated with the computing device

28. A non-transitory, computer-readable medium, comprising machine-readable instructions that, when executed by a processor of a computing device, cause the computing device to at least:
identify a future transaction requiring authentication, the future transaction being between a client device and a terminal;
determine a risk level associated with the future transaction;
generate pre-authentication data for the future transaction, the pre-authentication data comprising a pre-authentication key, transaction criteria, and the risk level; and
transmit the pre-authentication data to the client device.

29. The non-transitory, computer-readable medium of claim 28, wherein the machine-readable instructions, when executed by the processor, further cause the computing device to at least:
analyze historical transaction data associated with a user to detect a behavior pattern, the future transaction being identified based at least in part on the behavior pattern.

30. The non-transitory, computer-readable medium of claim 29, wherein the machine-readable instructions, when executed by the processor, further cause the computing device to at least:
generate input data based at least in part on the historical transaction data; and
apply the input data to a trained pattern detection model, the future transaction being identified based at least in part on an output of the trained pattern detection model.

31. The non-transitory, computer-readable medium of claim 30, wherein the machine-readable instructions, when executed by the processor, further cause the computing device to at least:
receive a notification from the client device indicating whether the terminal accepted or denied the future transaction with the authentication key; and
update the trained pattern detection model based at least in part on whether the terminal accepted or denied the future transaction.

32. The non-transitory, computer-readable medium of claim 28, wherein the machine-readable instructions further cause the computing device to at least:
receive a pre-authentication request for the future transaction from the client device, the future transaction being identified based at least in part on receiving the pre-authentication request, and the pre-authentication request comprising transaction details about the future transaction.

33. The non-transitory, computer-readable medium of claim 28, wherein the transaction criteria includes at least one of a merchant identifier, a maximum transaction amount, an expiration date, or a terminal identifier.
